(19) United States
(12) Patent Application Publication
(10) Pub. No.: US 2025/0173782 A1
(43) Pub. Date: May 29, 2025

(54) MACHINE LEARNING BASED APPROACH FOR AUTOMATICALLY PREDICTING A CLASSIFICATION FOR TRANSACTIONS BASED ON INDUSTRY NAME EMBEDDINGS

(71) Applicant: INTUIT INC., Mountain View, CA (US)

(72) Inventors: Jocelyn LU, Mountain View, CA (US); Heather Elizabeth SIMPSON, Sunnyvale, CA (US)

(21) Appl. No.: 18/520,693

(22) Filed: Nov. 28, 2023

(51) Int. Cl. G06Q 40/02; G06F 40/40

(52) U.S. Cl. CPC G06Q 40/02; G06F 40/40

(57) ABSTRACT

A method for training a machine learning model to automatically predict a classification for an uncategorized transaction includes: retrieving a plurality of historical transactions involving a plurality of different payors and a plurality of different payees; generating a first plurality of embeddings based, at least in part, on a subset of the historical transactions having a first type, wherein each of the first plurality of embeddings is representative of an industry name associated with one or more payors involved in the first set of historical transactions; generating training data for the machine learning model based, at least in part, on the first plurality of embeddings; and training the machine learning model through a supervised learning process using the training data.

### INTRODUCTION

Aspects of the present disclosure relate to training a machine learning model, such as a neural network, to automatically predict a classification for a transaction. In particular, the present disclosure relates to training the neural network to automatically predict the classification for the transaction based on industry name embeddings.

### BACKGROUND

Every year millions of people around the world utilize software applications to assist with countless aspects of life. Software applications may be used to automatically predict a classification for an uncategorized transaction. For instance, accounting software may assist a user (e.g., solopreneur) with bookkeeping by automatically predicting whether a given transaction involving the user is a business transaction or a personal transaction.

Machine learning techniques may be used to automatically predict a classification for a transaction. For example, given a set of training data, a machine learning model may generate and refine a function that predicts the classification (e.g., business or personal) for the transaction for the purpose of calculating a user's business related expenses. The machine learning model may be trained to automatically predict the transaction's classification based on the monetary amount and the description of the payee.

Existing machine learning techniques generally require large amounts of training data. However, the accuracy of such existing machine learning techniques is generally limited as a function of the training data. For example, training data used in existing machine learning techniques is generally based on limited information about a transaction, such as the details of the transaction itself. By relying on limited data points, existing machine learning techniques may, in some instances, incorrectly predict a classification for a given transaction.

What is needed are improved machine learning techniques for predicting a classification of a transaction with improved accuracy.

### BRIEF SUMMARY

Aspects and advantages of embodiments of the present disclosure will be set forth in part in the following description, or may be learned from the description, or may be learned through practice of the embodiments.

In one aspect, a method for training a machine learning model to automatically predict a classification for previously uncategorized transactions includes: retrieving a plurality of historical transactions involving a plurality of different payors and a plurality of different payees, wherein the plurality of historical transactions include a first set of historical transactions classified as being in a first category and a second set of historical transactions classified as being in a second category that is different from the first category; generating, by a first embedding model, a first plurality of embeddings based, at least in part, on the first set of historical transactions, wherein each of the first plurality of embeddings is representative of an industry name associated with one or more of payors involved in the first set of historical transactions; generating training data for the machine learning model based, at least in part, on the first plurality of embeddings; and training the machine learning model through a supervised learning process using the training data to automatically predict a classification for previously uncategorized transactions as being within the first category or the second category.

In another aspect, a system is provided that includes at least one memory and at least one processor configured to perform the method set forth above.

In yet another aspect, a method for automatically predicting a classification for a plurality of uncategorized transactions includes: receiving a plurality of uncategorized transactions involving a payor and a plurality of different payees; retrieving a machine learning model that has been trained through a supervised learning process based on labeled training data that includes a plurality of embeddings, wherein each of the embeddings is representative of an industry name associated with one or more of payors involved in historical transactions of a first type; providing inputs to the machine learning model based, at least in part, on the plurality of uncategorized transactions involving the payor and the plurality of different payees; receiving, from the machine learning model, a plurality of predictions, each of the predictions for a respective transaction of the plurality of uncategorized transactions and indicative of the respective transaction being of the first type or a second type; and displaying, via a user interface, the plurality of predictions.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for automatically predicting a category for a transaction according to some embodiments of the present disclosure.

FIG. 2 depicts a table illustrating historical transactions from which labeled training data may be generated to train a machine learning model to automatically predict a classification for transactions according to some embodiments of the present disclosure.

FIG. 3 depicts a user interface illustrating automated predictions for classifications of transactions according to some embodiments of the present disclosure.

FIG. 4 depicts a flow diagram of a method of a machine learning based approach for training a machine learning model to automatically predict a classification for transactions according to some embodiments of the present disclosure.

FIG. 5 depicts a flow diagram of a method of a machine learning based approach for automatically predicting a classification for transactions according to some embodiments of the present disclosure.

FIGS. 6A and 6B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to a particular machine learning technique in which a machine learning model (e.g., neural network) is trained based on industry name embeddings to automatically predict a classification (e.g., business or personal) for a transaction.

Conventional machine learning based techniques automatically predict a classification for a transaction based on limited features, such as the monetary amount involved in the transaction and/or the description of the payee involved in the transaction. However, these conventional techniques neglect features related to the payor, such as a description of an industry in which the payor is employed, and thus may incorrectly predict a classification for the transaction. For example, conventional machine learning based techniques may, by failing to consider the industry description for the payor, incorrectly predict that the transaction is a personal transaction when the transaction is actually a business transaction.

Embodiments of the present disclosure are directed to machine learning techniques in which a machine learning model (e.g., a neural network) is trained using training data that includes industry name embeddings to automatically predict a classification for a transaction. The machine learning techniques may include an industry embedding model that is configured to generate the industry name embeddings in a particular manner that produces beneficial results.

An embedding generally refers to a vector representation of an entity that represents the entity as a vector in n-dimensional space such that similar entities are represented by vectors that are close to one another in the n-dimensional space.

The industry embedding model may be trained using historical business transactions involving a plurality of different payors and a plurality of different payees. In one example, the industry embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

In some embodiments, the industry embedding model may be configured to convert the historical business transactions into a vector representation. For example, in some embodiments, each of the historical business transactions may be provided to the industry embedding model as a string of text (e.g., a sentence) that may be converted into the vector representation. In alternative embodiments, the industry embedding model may, itself, generate the sentence for each of the historical business transactions by concatenating the industry name descriptor for the payor to the unique payor/payee combination.

In some embodiments, the machine learning based techniques may include a transaction embedding model. The transaction embedding model may be configured to generate transaction embeddings that are included in the training data that is used to train the machine learning model to automatically predict a classification for a transaction. In some embodiments, the transaction embedding model may be a BERT, Sentence-BERT, Word2Vec, GloVe, or other type of embedding model configured to convert the historical transactions (e.g., both business and personal) into a vector representation. For example, in some embodiments, each of the historical transactions may be provided to the transaction embedding model as a string of text (e.g., a sentence) that may be converted into the vector representation. In alternative embodiments, the transaction embedding model may, itself, generate the sentence for each of the historical transactions by concatenating a descriptor of the payee to the unique payor/payee combination. It should be appreciated that transaction embeddings may be representative of similarities between different payees within the same category (e.g., business or personal). In alternative embodiments, industry name embeddings and transaction embeddings are generated by the same embedding model.

In some embodiments, the labeled training data that is used to train the machine learning model to automatically predict a classification of a transaction may, in addition to the industry name embeddings and the transaction embeddings, include labels associated with the historical transactions. For instance, the labels may correspond to the category (e.g., business or personal) for each of the historical transactions. Furthermore, in some embodiments, the labeled training data may include metadata associated with one or more of the historical transactions. Metadata may include, without limitation, a monetary value associated with the historical transaction(s).

Once the machine learning model is trained to automatically predict a classification for a transaction, the machine learning model may operate in an inference mode in which the machine learning model is provided transactions for a particular user over a period of time (e.g., day, week, month, year, etc.). In some embodiments, industry name embeddings and transaction embeddings may be generated using the transactions for the particular user over the period of time. For instance, the industry name embeddings and the transaction embeddings may be generated by the industry embedding model and transaction embedding model, respectively. The industry name embeddings and transaction embeddings may be provided as an input to the machine learning model. Based on the input (e.g., industry name embeddings and transaction embeddings), the machine learning model may output a prediction for a classification for each of the transactions.

In some embodiments, the output may be displayed in a user interface associated with a software application (e.g., an accounting software). For instance, the transactions for the particular user over the period of time may be displayed one after another in a table and the output (e.g., prediction of the classification) of the machine learning model may be included in the table. In this manner, the user may view the predicted classification for each of the transactions and may interact with the user interface to provide feedback in the event the predicted classification for one or more of the transactions is incorrect or to accept a predicted classification.

In some embodiments, the initial labeled training data that was used to train the machine learning model to automatically predict a classification for transactions may be updated based on the user feedback regarding the output of the machine learning model for one or more transactions provided after the machine learning model was initially trained. For instance, the transactions for which user feedback was provided may be added to the labeled training data with a label that is based on the user feedback. In this manner, the training data can incorporate user feedback and can be used to re-train the machine learning model to improve the accuracy of predictions made by the machine learning model over time.

Example aspects of the present disclosure provide numerous technical effects and benefits. For instance, since the disclosed machine learning techniques includes training a machine learning model (e.g., neural network) using industry name embeddings, the trained machine learning model may account for features of the payor, specifically the industry description of the payor, which may affect the prediction of the classification for a transaction involving the payor. In this manner, machine learning models trained according to the techniques described herein may be improved (e.g., more accurate) compared to machine learning models trained according to conventional techniques.

Furthermore, by improving the accuracy of predictions output by the machine learning model, techniques described herein avoid the computing resource utilization that would otherwise be associated with generating and providing inaccurate predictions for transactions that would require additional actions from the user to ensure the transactions are correctly classified and additional processing to handle such actions.

Machine Learning Based Techniques for Predicting a Classification of Transactions in a Software Application

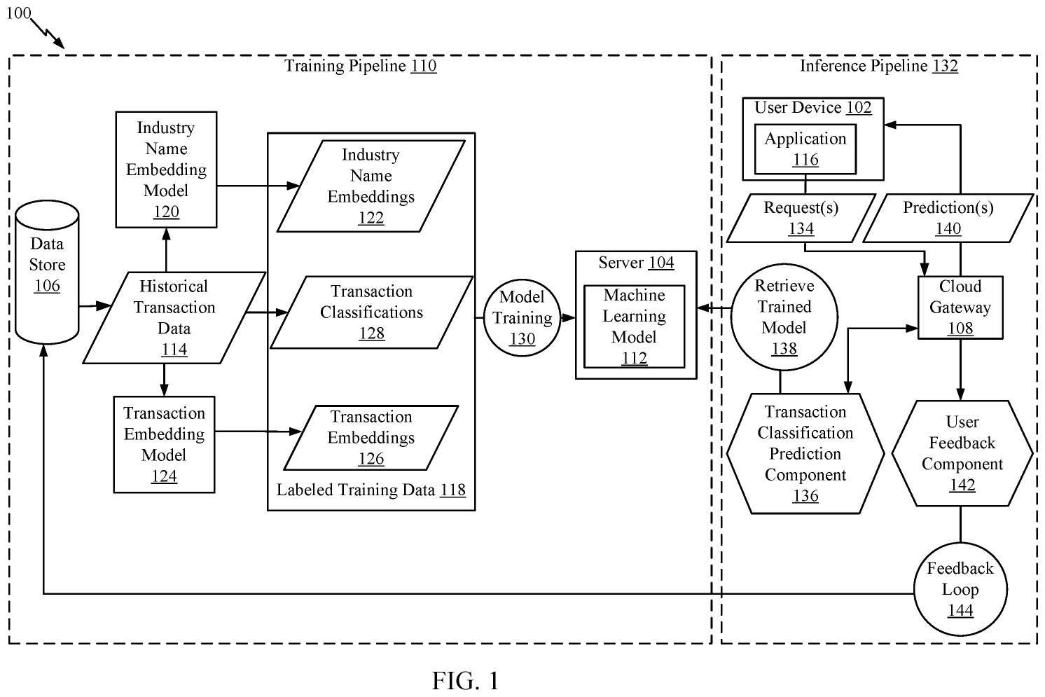

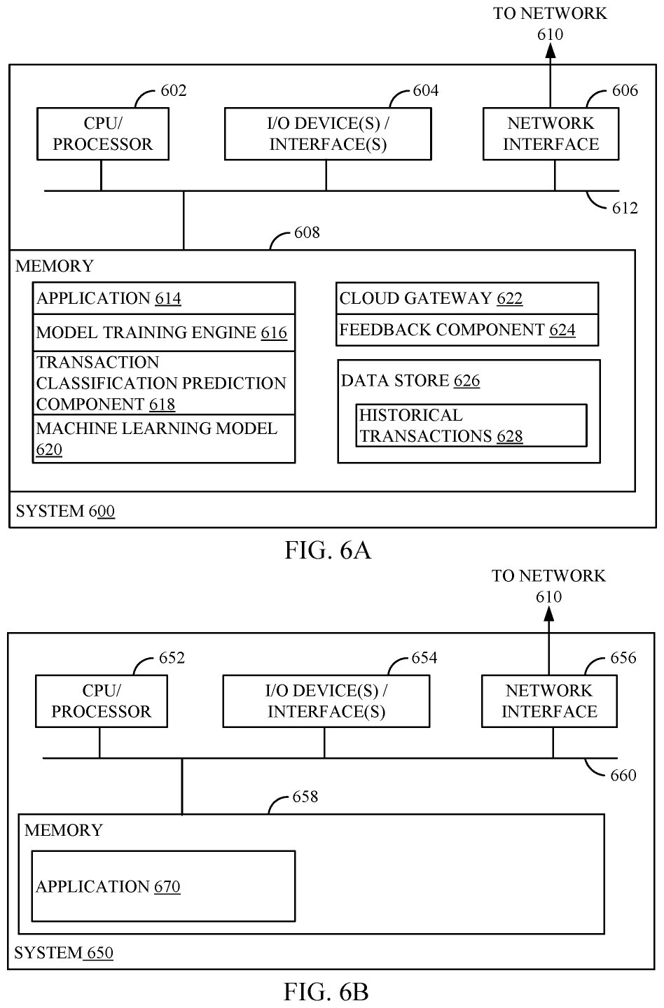

FIG. 1 illustrates a computing environment 100 for automatically predicting a classification for transactions using machine learning techniques according to embodiments of the present disclosure. The computing environment 100 includes a user device 102, a server 104, a data store 106, and a cloud gateway 108, each of which may be implemented via one or more physical computing devices, such as the computing systems discussed below with respect to FIGS. 6A and 6B. It should be appreciated that the user device 102, the server 104, the data store 106, and the cloud gateway 108, as well as other components described herein, may be communicatively coupled to one another via one or more networks (not shown). The network(s) may include, without limitation, a wide area network (WAN), a local area network (LAN), and/or a cellular network, and more generally may include any wired or wireless connection over which data may be communicated.

The computing environment includes a training pipeline 110. The training pipeline 110 includes aspects related to generating training data and then using that training data to train a machine learning model 112 according to techniques described herein. For example, the processes described with respect to the training pipeline 110 may be performed by a model training component running on one or more physical computing devices (e.g., the same as or separate from the server 104). The training pipeline 110 may represent operations that are performed initially in order to generate the machine learning model 112. Additionally, the training pipeline 110 may represent operations that are performed iteratively over time, such as in real-time and/or at regular intervals, to re-train the machine learning model 112.

In order to generate training data, historical data 114 is retrieved from the data store 106. It should be appreciated that the data store 106 generally represents a data storage entity, such as a database or repository that stores data related to a software application, such as an application 116 that is running on the user device 102. Data related to the software application (e.g., application 116) may include data related to use of the software application by a plurality of users (e.g., that interact with the application via a plurality of user devices similar to the user device 102).

In some embodiments, the application 116 may be an accounting software application and the historical data 114 may include a plurality of transactions involving a plurality of payors and payees. It should be appreciated that “transactions” refers to a financial transaction in which a payor pays a payee (e.g., vendor) a sum of money for an item (e.g., product and/or service) provided by the payee. The historical data 114 may include, for each of the historical transactions, a label that denotes whether a respective historical transaction was classified as a business transaction or a personal transaction. Furthermore, the historical data 114 may include an industry description for each of the plurality of payors. For instance, the plurality of payors may include a payor that is employed as a rideshare driver, and the historical data 114 may include an industry description for the payor that indicates that the payor works in the rideshare industry.

It should be appreciated that what constitutes a business transaction may vary across industries. For example, a payor employed as a rideshare driver may mark a transaction with a gas station (e.g., payee) for gas/fuel as a business transaction. Conversely, a payor employed as a craft seller may mark the same transaction as a personal transaction. As will now be discussed, labeled training data 118 may be generated to train the machine learning model 112 to automatically predict a classification for a transaction based, at least in part, on attributes of a payor associated with the transaction. In this manner, the payor will not need to interact with the application 116 (e.g., a user interface displaying transactions involving the payor over a period of time) to manually mark the transaction within the application 116 as a business transaction, a personal transaction, or a split between the two.

The training pipeline 110 may include an industry embedding model 120. The industry embedding model 120 may be trained using a portion of the historical data 114 retrieved from the data store 106. For instance, the industry embedding model 120 may be trained using transactions within the historical data 114 that are labeled as business transactions. In some embodiments, each of the business transactions may be provided to the industry embedding model 120 as a sentence that includes a plurality of different features of the respective transaction. For example, the features may include, without limitation, a description of the payor (e.g., user of application 116), a description of the payee, and the industry description for the payor. In some embodiments, the description of the payor may include a unique identifier for the payor. Alternatively, or additionally, the description of the payee may, in some embodiments, include a name of the payee.

In alternative embodiments, the industry embedding model 120 may simply be provided all the business transactions included in the historical data 114 and may, itself, generate a sentence for each of the business transactions. For example, the industry embedding model 120 may generate a sentence for a particular business transaction by concatenating the industry description for a respective payor associated with the business transaction to a unique payor/payee combination for the business transaction. It should be appreciated that the payor/payee combination may refer to the combination of the description of the payor and the description of the payee.

To generate the industry name embeddings 122, the industry embedding model 120 may perform one or more operations. For example, the industry embedding model 120 may convert each of the business transactions into a suitable form (e.g., sentences) for use as training data for the industry embedding model 120. For instance, sensitive information in the business transactions may be stripped out as appropriate (e.g., by using machine learning, rules, and/or regular expressions to identify such sensitive information and removing identified sensitive information and/or replacing such sensitive information with dummy information).

It should be appreciated that an industry name embedding generally refers to a vector representation of a particular industry in n-dimensional space. Furthermore, the particular industry that the industry name embedding represents may be included in a list of different industries recognized by an entity (e.g., government agency). In operation, the industry embedding model 120 may generate a first industry name embedding representative of a first industry (e.g., transportation) included in the list of different industries for a transaction in the historical data 114 that involves a payor having an industry description (e.g., rideshare driver) associated with the first industry. Additionally, the industry embedding model 120 may generate a second industry name embedding representative of a second industry included in the list of different industries for a transaction in the historical data 114 that involves a payor having an industry description associated with the second industry.

It should also be appreciated that the industry embedding model 120 may include any suitable type of machine learning model implementing any suitable type of embedding technique. For instance, in some embodiments, the industry embedding model 120 may be configured to implement a Word2Vec embedding technique. This is included only as an example, and other techniques for generating embeddings are possible.

The training pipeline 110 may include a transaction embedding model 124. The transaction embedding model 124 may be trained using the historical data 114 retrieved from the data store 106. For instance, transactions (that is, both business and personal) included in the historical data 114 may be provided to the transaction embedding model 124. In some embodiments, each of the transaction may be provided as a sentence that includes a plurality of different features. For example, the features may include, without limitation, a description of the payee for a particular transaction.

In alternative embodiments, the transaction embedding model 124 may simply be provided all the transactions included in the historical data 114 and may, itself, generate a sentence for each of the transactions. For example, the transaction embedding model 124 may generate a sentence for a particular transaction by concatenating a description for the payee associated with a particular transaction to a unique payor/payee combination associated with the particular transaction.

It should be appreciated that the input features provided to the transaction embedding model 124 may include more or fewer features than discussed above. For instance, in some embodiments, the industry name embeddings 122 generated by the industry embedding model 120 may be an input feature for the transaction embedding model 124.

To generate transaction embeddings 126, the transaction embedding model 124 may perform one or more operations. For example, the transaction embedding model 124 may convert each of the transactions into a suitable form (e.g., sentences) for use as training data for the transaction embedding model 124. Alternatively, or additionally, the transaction embedding model 124 may strip out sensitive information in each of the transactions as appropriate (e.g., by using machine learning, rules, and/or regular expressions to identify such sensitive information and removing identified sensitive information and/or replacing such sensitive information with dummy information).

The labeled training data 118 that is used to train the machine learning model 112 to automatically predict a classification for transactions may include the industry name embeddings 122 output by the industry embedding model 120, the transaction embeddings 126 output by the transaction embedding model 124, and transaction classifications 128 (e.g., labels) included in the historical data 114. By including the industry name embeddings 122 as an input feature, techniques described herein allow the machine learning model 112 to be trained to recognize latent relationships among payors based on their industry description. In this manner, the machine learning model 112 may better predict transactions as business or personal transactions due, at least in part, to being trained with the industry name embeddings 122.

At model training 130, the labeled training data 118 is used to train the machine learning model 112 through a supervised learning process. In some embodiments, the supervised learning process may include providing training inputs (e.g., features, such as an industry name embedding and a transaction embedding, of a transaction) as inputs to the machine learning model 112. The machine learning model 112 may process the training inputs and output predictions (e.g., an indication of whether the transaction is a business transaction or a personal transaction). In some embodiments, the output prediction may include a confidence score indicating a level of confidence that the transaction falls within the predicted classification (that is, business transaction or personal transaction). The predictions are compared to the known labels associated with the training inputs (e.g., a binary label indicating how such a transaction has historically been categorized) to determine the accuracy of the machine learning model 112, and parameters of the machine learning model 112 are iteratively adjusted until one or more conditions are met. For instance, the one or more conditions may relate to an objective function (e.g., a cost function or a loss function) for optimizing one or more variables (e.g., model accuracy, model precision, model recall and/or the like). In some embodiments, the conditions may relate to whether the predictions produced by the machine learning model 112 based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

In some embodiments, the machine learning model 112 may be a neural network. It should be appreciated, however, that the scope of the machine learning model 112 within the present disclosure is by no means limited to neural networks and therefore may include other types of machine learning models (e.g., that is trained through supervised learning methods).

As a result of the model training 130, the machine learning model 112 is configured to recognize latent relationships among transactions by users in a plurality of different industries and is able to apply knowledge gained from the labeled training data 118 for transactions by users in a plurality of different industries according to the connections and/or other parameters of the machine learning model 112 that were configured during the model training 130.

The machine learning model 112 (e.g., once trained) may be deployed to the server 104, where it can be used to predict a classification (e.g., business or personal) for one or more transactions. In some embodiments, an object is created that stores the machine learning model 112 artifact. For example, the server 104 may be a cloud server or other type of server that can be accessed in order to retrieve the machine learning model 112 (e.g., retrieve the object that includes the model artifact) for use in predicting a classification for a given transaction by a user.

In some embodiments, the cloud gateway 108 may be associated with the server 104 and may allow user devices, such as the user device 102, to request and receive predictions for one or more transactions, such as via calls to an application programming interface (API), and the cloud gateway 108 orchestrates access to the server 104 in order to retrieve and/or otherwise use the machine learning model 112 for purposes of determining such predictions. It is noted that the particular architectures described herein, such as a client-server architecture, the use of a cloud server, the use of a cloud gateway, the use of an API, and/or the like are included as examples, and techniques described herein may be employed with different architectures (e.g., as a standalone system on a single device, and/or with more or fewer local and/or remote devices and/or components).

The computing environment 100 may include an inference pipeline 132. The inference pipeline 132 may include aspects related to using the machine learning model 112 (e.g., trained as described above with respect to the training pipeline 110) to automatically predict a classification (e.g., business or personal) for one or more transactions associated with a user of the application 116 (e.g., tax preparation software). For example, the processes described with respect to the inference pipeline 132 may be performed by the application 116 and/or one or more additional local or remote components running on one or more physical computing devices (e.g., the same as or separate from the user device 102).

The user device 102 generally represents a computing device by which a user interacts with the application 116. For example, the application 116 may be a standalone application or client-side component of a client-server paradigm that also includes a server-side component with which the application 116 interacts (e.g., via API calls). Such a server-side component may run on the server 104 or a different server.

The application 116 generally represents a software application that allows a user to perform one or more workflows. In one particular example, the application 116 may be an accounting software application that allows users to track expenses (e.g., personal and business transactions).

The application 116 (or a remote component, such as a server-side application) may use the machine learning model 112 to automatically predict a classification (e.g., business or personal) for one or more transactions associated with a user of the user device 102. For example, a user of the user device 102 may land on a page within the application 116 that prompts the application to obtain a plurality of transactions for the user that occurred over a period of time (e.g., a week, a month, a year, etc.). In some embodiments, the transactions for the user may be stored on the server 104, and the application 116 may retrieve the transactions from the server 104. In alternative embodiments, the transactions may be stored on a sever other than the server 104. For example, the transactions may be stored on a server associated with a financial institution with which the user does his/her banking. In such embodiments, the application 116 may communicate with the server associated with the financial institution to obtain the transactions for the user over the period of time. Transactions may generally be retrieved from one or more local or remote components. For example, some transactions may already be locally stored on user device 102 (e.g., if the user provides transaction records directly to user device 102), and so may be retrieved from local storage.

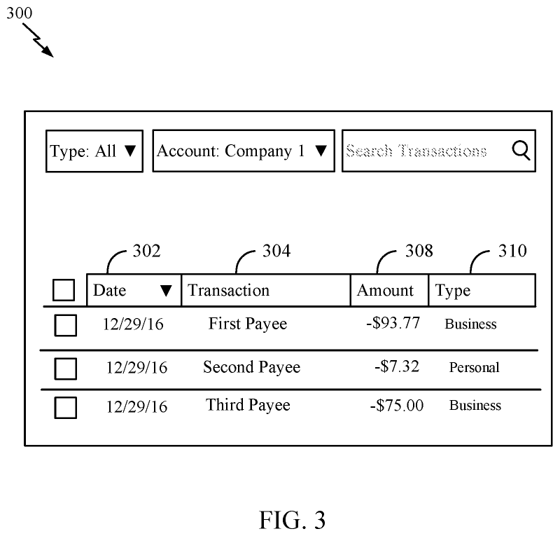

In addition to retrieving the transactions, the application 116 (e.g., which could be a web browser that interacts with a remote application) may request model-based classification prediction (that is, business or personal) for each of the transactions retrieved for the user. It should be appreciated that the model-based classification prediction for each of the transactions may be presented in a user interface (as described in more detail in FIG. 3) associated with the application 116. For instance, the user device 102 with which the user is interacting may include a display capable of presenting the model based classification predictions for viewing by the user.

In some embodiments, the application 116 may send one or more requests 134 to the cloud gateway 108 in order to invoke functionality exposed by the cloud gateway 108, such as requesting classification predictions for the transactions. The request(s) 134 may prompt an object (e.g., transaction classification prediction component 136) that includes the machine learning model 112 artifact to be retrieved. Once the machine learning model 112 has been retrieved (e.g., via the transaction classification prediction component 136 at step 138), the machine learning model 112 may be returned to the application 116 (e.g., via one or more classification predictions 140 in response to the one or more requests 134) or may be run on a device other than the user device 102, such as the server 104 (e.g., the machine learning model 112 artifact may be used to run the machine learning model 112 on the server 104 or another server). In some embodiments, the machine learning model 112 runs on the server 104, and features (e.g., industry name embedding and transaction embedding generated by the industry embedding model 120 and the transaction embedding model 124, respectively) for each of the transactions to be provided as inputs to the machine learning model 112 are sent to the server 104 for use in predicting a classification for each of the transactions. For example, in some embodiments, each of the transactions retrieved for the user may be provided to the industry embedding model 120 and the transaction embedding model 124 to generate industry name embeddings and transactions embeddings that may be provided as inputs to the machine learning model 112. In other embodiments, transaction classification prediction component executes and uses machine learning model 112 itself (e.g., on one or more computing devices). More generally, machine learning model 112 is used to predict classifications for each transaction and the predicted classifications may be displayed to a user, regardless of which devices are used to run which components.

Based on the features of the transactions that are provided as an input to the machine learning model 112, the machine learning model 112 may, for each of the transactions, output a classification prediction 140. For example, the classification prediction 140 may indicate whether a particular transaction of the user's is predicted to be a business transaction or a personal transaction. The classification prediction 140 may be provided to the user device 102 (e.g., via the cloud gateway 108).

The user may provide feedback with respect to the classification predictions for the one or more transactions, and the user feedback may be used to generate updated training data for re-training the machine learning model 112. For example, the application 116 may provide such feedback for use in re-training by interacting with the cloud gateway 108 (e.g., through an API call), and a user feedback component 142 (e.g., a method invoked via the API call) may provide the user feedback to the model training 130 component in a feedback loop. In certain embodiments, the user feedback on the classification prediction 140 for one or more of the transactions may be provided to the data store 106 via a feedback loop 144. In this manner, the historical data 114 may be updated to include the transaction(s) for which user feedback was provided and, as a result, the updated historical data 114 may be used to update the labeled training data 118, which may be used to re-train the machine learning model 112.

### Example Historical Transactions

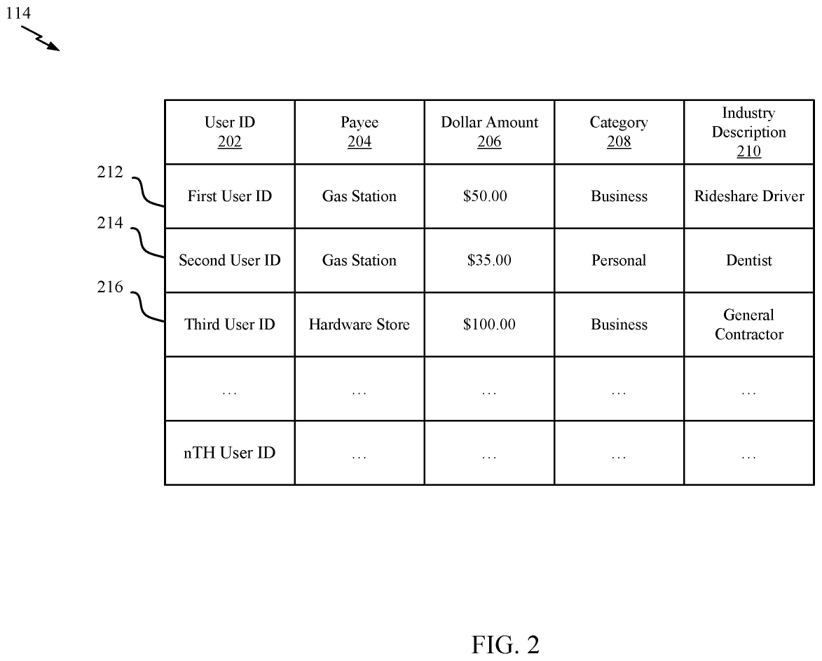

FIG. 2 illustrates the historical data 114 from which labeled training data may be generated for training a machine learning model (such as the machine learning model 112 in FIG. 1) to automatically predict a classification for a given transaction associated with a user according to some embodiments of the present disclosure.

The historical data 114 is illustrated as a table that includes a plurality of rows and a plurality of columns. Each of the rows in the table may correspond to a different transaction. Each of the columns may correspond to a different feature associated with each of the transactions. For instance, a first column 202 titled “User ID” may be for a unique identifier associated with a user (e.g., payor) of a software application (such as the application 116 in FIG. 1). A second column 204 titled “Payee” may include a descriptor of a vendor/payee associated with a given transaction. A third column 206 titled “Dollar Amount” may indicate an amount of money exchanged between the user (e.g., payor) and payee for a given transaction. A fourth column 208 titled “Category” may indicate a classification for a given transaction. For instance, a transaction classified as a business transaction may include data in the “Category” column (e.g., fourth column 208) to indicate that the transaction is a business transaction. Alternatively, a transaction classified as a personal transaction may include data in the “Category” column to indicate that the transactions is a personal transaction. A fifth column 210 titled “Industry Description” may include data indicative of an industry in which a respective user (e.g., payor) involved in a given transaction is employed. In some embodiments, industry descriptions included in the “Industry Description” column may be generated based, at least in part, on a list of a plurality of different industries as recognized by a standard, such as the North American Industry Classification System (NAICS). It should be appreciated, however, that the scope of the list of different industries is not intended to be limited to such a standard created for North America and may incorporate standards established for other continents (e.g., Europe, Asia, etc.) as well.

As shown, a first transaction (e.g., indicated by a first row 212 in the table) may be populated with information for each of the above-mentioned categories (e.g., denoted by the different columns in the table). For instance, the table may indicate that the first transaction was between a first user (e.g., denoted by unique ID for first user) and a gas station. The table may indicate that the first user paid the gas station a sum of money (e.g., denoted by $50.00 in the third column 206) for gas/fuel. In addition, the table may indicate that the first transaction was classified as a business transaction and may further indicate that the first user is employed as rideshare driver. As shown, the table may be populated with details for a second transaction (e.g., indicated by a second row 214 in the table) and a third transaction (e.g., indicated by a third row 216 in the table).

It should be appreciated that the historical data 114 may include a large volume of transactions involving a plurality of different users across a plurality of different industries. In this manner, the labeled training data (such as the labeled training data 118 in FIG. 1) that is used to train a machine learning model (such as the machine learning model 112 in FIG. 1) may account for several different industries and therefore allow the machine learning model to learn latent relationships between transactions within a given industry and between different industries and therefore make improved predictions for classifications of transactions.

### Example User Interface Illustrating Classification Predictions for Various Transactions

FIG. 3 depicts a user interface 300 associated with an application (such as the application 116 in FIG. 1) according to some embodiments of the present disclosure. As shown, the user interface 300 may include a list of a transactions associated with a user (e.g., Company 1) of the application. For instance, the list of transactions may include three separate transactions involving the user on a particular day (e.g., Dec. 29, 2016). It should be appreciated that the user interface 300 may display transactions involving the user over a longer period of time (e.g., a week, a month, a year).

The user interface 300 may display various features for each of the transactions. For instance, the user interface 300 may display a day 302 on which a given transaction took place. The user interface 300 may display a descriptor 304 (e.g., the name) of the vendor/payee associated with a given transaction. The user interface 300 may display an amount 306 of money that the user paid a respective vendor/payee for a given transaction. Finally, the user interface 300 may display a classification prediction 308 determined by a machine learning model (such as the machine learning model 112 in FIG. 1) that is trained to predict a classification (e.g., business or personal) for transactions. In some embodiments, the user interface 300 allows the user to provide feedback with respect to the predicted classifications, such as accepting, rejecting, or changing the predicted classification. For example, while not shown, one or more user interface controls may be displayed that allow a user to select a transaction and provide feedback with respect to the predicted classification for the transaction. Notably, by predicting transaction classifications with a high level of accuracy due to the use of industry name embeddings and transaction embeddings as inputs to a machine learning model as described herein, embodiments of the present disclosure reduce the amount of time required to classify transactions (e.g., because the user will not need to manually enter or correct many transaction classifications), thereby improving the functioning of the application, improving the user experience, and avoiding computing resource utilization that would otherwise occur in association with generating, displaying, and/or correcting inaccurate classification predictions and/or processing manual entry of classifications for a large number of transactions (e.g., a process which otherwise consumes or even monopolizes display, memory, and/or processing resources for large amounts of time).

### Method for Training a Machine Learning Model to Automatically Predict a Classification for Transactions

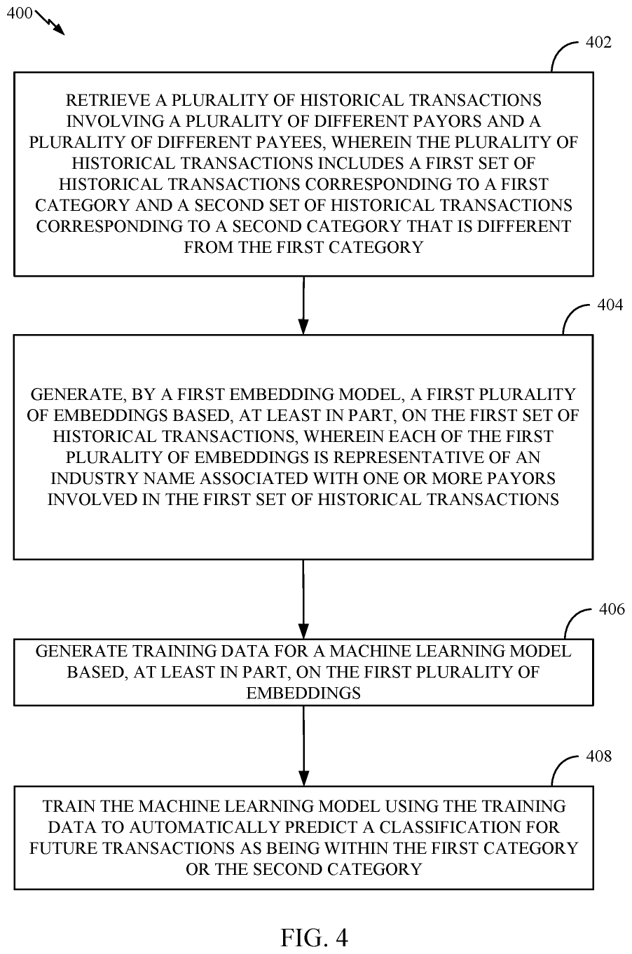

FIG. 4 is a flow diagram of an example method 400 of a machine learning based approach for training a machine learning model (e.g., neural network) to automatically predict a classification for transactions according to some embodiments of the present disclosure. The method 400 may be performed by instructions executing on a processor of a server (such as the server 104 of FIG. 1).

At (402), the method 400 may include retrieving a plurality of historical transactions involving a plurality of different payors and a plurality of different payees. The plurality of historical transactions may include a first set of historical transactions classified as being in a first category (e.g., business transactions/expenses) and a second set of historical transactions classified as being in a second category (e.g., personal transactions/expenses) that is different (e.g., separate) from the first category. In some embodiments, the historical transactions may be obtained from a data store (such as the data store 106 in FIG. 1).

At (404), the method 400 may include generating a first plurality of embeddings (such as the industry name embeddings 122 in FIG. 1) based, at least in part, on the first set of historical transactions included in the plurality of historical transactions retrieved at (402). In some embodiments, the first plurality of embeddings may be generated by an embedding model (such as the industry embedding model 120 in FIG. 1). Each of the first plurality of embeddings may be representative of an industry name included in a list of a plurality of different industries. In some embodiments, multiple of the first plurality of embeddings may be representative of the same industry name. In alternative embodiments, each of the first plurality of embeddings may be representative of a different industry name included in the list of the plurality of different industries.

In some embodiments, each of the first plurality of embeddings may be representative of an industry name associated with an industry description for a payor involved in a corresponding historical transaction included in the first set of historical transactions. For example, a first embedding included in the first plurality of embeddings may be representative of a first industry name (e.g., transportation) included in the list of different industries and associated with a first industry description (e.g., rideshare driver) for a first payor involved in a first historical transaction included in the first set of historical transactions. Conversely, a second embedding included in the first plurality of embeddings may be representative of a second industry name (e.g., arts) associated with a second industry description (e.g., crafter) for a second payor involved in a second historical transaction included in the first set of historical transactions.

In some embodiments, each of the of the first plurality of embeddings may be representative of a respective industry included in the list of respective industries and may be generated based on those historical transactions included in the first set of historical transactions and involving payors having an industry description that is associated with the respective industry. For example, a first embedding included in the first plurality of embeddings may be representative of a first industry included in the list of different industries and associated with an industry description for multiple payors involved in multiple transactions included in the first set of historical transactions.

At (406), the method 400 may include generating training data for a machine learning model (such as the machine learning model 112 in FIG. 1) based, at least in part, on the first plurality of embeddings generated at (404). For instance, the first plurality of embeddings may be combined with labels (e.g., first category or second category) for each of the plurality of historical transactions retrieved at (402) to create labeled training data for training the machine learning model.

At (408), the method 400 may include training the machine learning model using the training data generated at (406) to automatically predict a classification for future transactions as being within the first category or the second category.

In some embodiments, the method may include generating a second plurality of embeddings based, at least in part, on the plurality of historical transactions retrieved at (402). In some embodiments, the first second plurality of embeddings may be generated by an embedding model (such as the transaction embedding model 124 in FIG. 1). The embedding model may be configured to convert the historical transactions (both personal and business) into the second plurality of embeddings. Since payors tend to categorize transactions with payees similarly, the second plurality of embeddings may be representative of similarities (e.g., in whether transactions are classified as business or personal) amongst different payees.

### Method for Automatically Predicting a Classification for Transactions

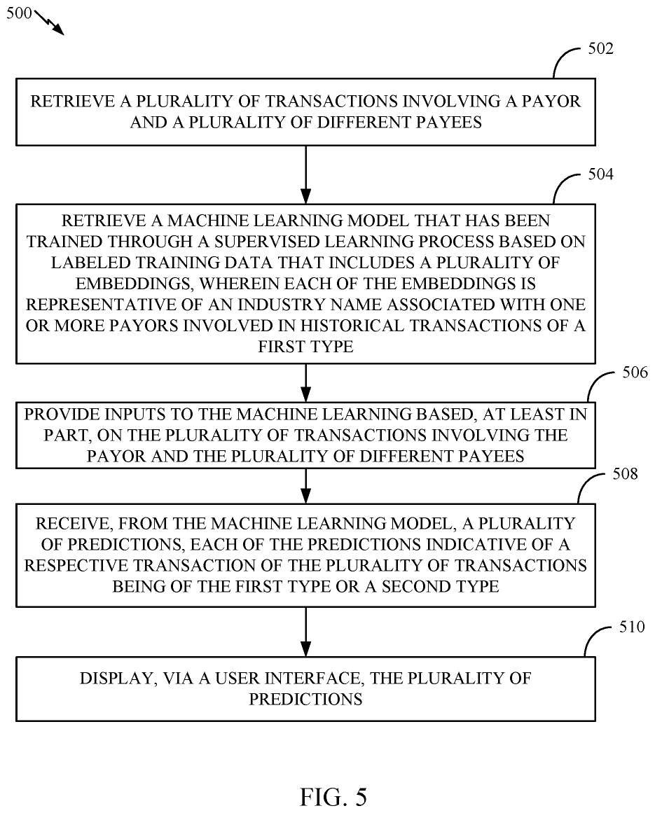

FIG. 5 is a flow diagram of an example method 500 of a machine learning based approach for automatically predicting a classification for transactions according to some embodiments of the present disclosure. The method 500 may be performed by instructions executing on a processor of a server (such as the server 104 of FIG. 1).

At (502), the method 500 may include retrieving a plurality of uncategorized transactions involving a payor and a plurality of different payees. In some embodiments, the uncategorized transactions may be retrieved as a result of the payor interacting with a software application (such as the application 116 in FIG. 1). For example, the payor may land on a page within the application that causes the uncategorized transactions between the payor and the plurality of different payees to be obtained over a period of time (e.g., day, week, month, year). In some embodiments, the transactions may be retrieved from a server associated with a financial institution associated with the payor.

At (504), the method 500 may include retrieving a machine learning model (such as the machine learning model 112 in FIG. 1) that has been trained through a supervised learning process based on labeled training data (such as the labeled training data 118 in FIG. 1) that includes a plurality of embeddings (such as the plurality of industry name embeddings 122 in FIG. 1). Each of the embeddings may be representative of an industry name associated with one or more payors involved in historical transactions of a first type (e.g., business).

At (506), the method 500 may include providing inputs to the machine learning model based, at least in part, on the plurality of transactions involving the payor and the plurality of different payees. For instance, in some embodiments, the inputs may include embeddings associated with each of the plurality of transactions. More specifically, for each of the transactions, a first embedding (e.g., industry name embedding) and a second embedding (e.g., transaction embedding) may be generated by a first embedding model (such as the industry embedding model 120 in FIG. 1) and a second embedding model (such as the transaction embedding model 124 in FIG. 1), respectively.

At (508), the method 500 may include receiving, from the machine learning model, a plurality of predictions based on the inputs provided to the machine learning model at (506). Each of the plurality of predictions may be associated with a respective transaction of the plurality of uncategorized transactions retrieved at (502) and may indicative whether the respective transaction is of the first type (e.g., business transaction) or a second type (e.g., personal transaction).

At (510), the method 500 may include displaying, via a user interface, the plurality of predictions for viewing by a user, such as the payor. For example, the user interface may display a table of the transactions and may include the predicted category for each of the transactions.

In some embodiments, the user may provide feedback on one or more of the predictions received at (508). Furthermore, in some embodiments, the labeled training data for the machine learning model may be updated based on the feedback and the updated labeled training data may be used to re-train the machine learning model. In this manner, the machine learning model may be improved over time through user feedback provided on predictions for live transactions, such as the plurality of transactions retrieved at (502). After re-training, the machine learning model may be used again to determine a subsequent classification prediction for a transaction with improved accuracy.

### Example Computing Systems

FIG. 6A illustrates an example computing system 600 with which embodiments of the disclosure related to automatically predicting a classification for a transaction may be implemented. For example, the computing system 600 may be representative of the server 104 of FIG. 1.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes application 614, transaction classification prediction component 618, machine learning model 620, cloud gateway 622, feedback component 624 and data store 626, which may be representative of application 116, model training 130, transaction classification prediction component 136, machine learning model 112, cloud gateway 108, user feedback component 142, and data store 106 of FIG. 1. Furthermore, the historical transactions 628 included in the data store 626 may include, for example, the historical data 114 of FIG. 1. The memory 608 further includes a model training engine 616, which may perform operations described herein for training the machine learning model 620, such as corresponding to the training pipeline 110 of FIG. 1.

FIG. 6B illustrates an example computing system 650 with which embodiments of the disclosure related to automatically predicting a classification for a transaction may be implemented. For example, the computing system 650 may be representative of the user device 102 of FIG. 1.

The computing system 650 includes a central processing unit (CPU) 652, one or more I/O device interfaces 654 that may allow for the connection of various I/O devices 654 (e.g., keyboards, displays, mouse devices, pen input, etc.) to the computing system 650, a network interface 656, a memory 658, and an interconnect 660. It is contemplated that one or more components of the computing system 650 may be located remotely and accessed via the network 610. It is further contemplated that one or more components of the computing system 650 may include physical components or virtualized components.

The CPU 562 may retrieve and execute programming instructions stored in the memory 658. Similarly, the CPU 652 may retrieve and store application data residing in the memory 558. The interconnect 660 transmits programming instructions and application data, among the CPU 652, the I/O device interface 654, the network interface 656, the memory 658. The CPU 652 is included to be representative of a single CPU, multiple CPUs, a single CPU having multiple processing cores, and other arrangements.

Additionally, the memory 658 is included to be representative of a random access memory or the like. In some embodiments, the memory 658 may include a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

As shown, the memory 658 may include a software application 670, such as the application 116 discussed above with reference to FIG. 1.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
retrieving a plurality of historical transactions involving a plurality of different payors and a plurality of different payees, wherein the plurality of historical transactions include a first set of historical transactions classified as being in a first category and a second set of historical transactions classified as being in a second category that is different from the first category;
generating, by a first embedding model, a first plurality of embeddings based, at least in part, on the first set of historical transactions, wherein each of the first plurality of embeddings is representative of an industry name associated with one or more payors involved in the first set of historical transactions;
generating training data for a machine learning model based, at least in part, on the first plurality of embeddings; and
training the machine learning model through a supervised learning process using the training data to automatically predict a classification for previously uncategorized transactions as being within the first category or the second category.

2. The method of claim 1, wherein generating the first plurality of embeddings comprises:
generating a plurality of sentences based on the first set of historical transactions, wherein each of the plurality of sentences corresponds to a respective historical transaction in the first set of historical transactions and includes: (i) a respective payor and payee combination; and (ii) an industry description of the respective payor; and
generating the first plurality of embeddings based, at least in part, on the plurality of sentences.

3. The method of claim 2, wherein generating the plurality of sentences comprises, for each of the plurality of sentences, concatenating the industry description of the respective payor to the respective payor and payee combination.

4. The method of claim 1, further comprising:
generating, by a second embedding model, a second plurality of embeddings based, at least in part, on the plurality of historical transactions, wherein the second plurality of embeddings are representative of similarities amongst the payees, and
wherein generating the training data for the machine learning model comprises combining the first plurality of embeddings and the second plurality of embeddings to form the training data.

5. The method of claim 4, wherein generating the second plurality of embeddings comprises:
generating a plurality of sentences based on the historical transactions, wherein each of the sentences corresponds to a respective historical transaction and includes: (i) a respective payor and payee combination; and (ii) a description of the payee.

6. The method of claim 5, wherein generating the plurality of sentences comprises, for each of the plurality of sentences, concatenating the description of the respective payee to the respective payor and payee combination.

7. The method of claim 1, wherein training the machine learning model through the supervised learning process comprises:
providing training inputs from the training data to the machine learning model;
obtaining outputs from the machine learning model based on the training inputs; and
iteratively adjusting parameters of the machine learning model based on comparing the outputs to labels associated with the training inputs in the training data.

8. The method of claim 1, wherein the machine learning model comprises a neural network.

9. A system comprising:
one or more processors; and
one or more memory configured to store computer executable instructions that, when executed by the one or more processors, cause the one or more processors to:
retrieve a plurality of historical transactions involving a plurality of different payors and a plurality of different payees, wherein the plurality of historical transactions include a first set of historical transactions classified as being in a first category and a second set of historical transactions classified as being in a second category that is different from the first category;
generate a first plurality of embeddings based, at least in part, on the first set of historical transactions, wherein each of the first plurality of embeddings is representative of an industry name associated with one or more payors involved in the first set of historical transactions;
generate training data for a machine learning model based, at least in part, on the first plurality of embeddings; and
train the machine learning model through a supervised learning process using the training data to automatically predict a classification for previously uncategorized transactions as being within the first category or the second category.

10. The system of claim 9, wherein to generate the first plurality of embeddings, the computer executable instructions, when executed by the one or more processors, cause the one or more processors to:
generate a plurality of sentences based on the first set of historical transactions, wherein each of the plurality of sentences corresponds to a respective historical transaction in the first set of historical transactions and includes: (i) a respective payor and payee combination; and (ii) an industry description of the respective payor; and
generate the first plurality of embeddings based, at least in part, on the plurality of sentences.

11. The system of claim 10, wherein to generate the plurality of sentences, the computer executable instructions, when executed by the one or more processors, cause the one or more processors to, for each respective historical transaction in the first set of historical transactions, concatenate the industry description of the respective payor to the respective payor and payee combination.

12. The system of claim 9, wherein the computer executable instructions, when executed by the one or more processors, further cause the one or more processors to:
generate a second plurality of embeddings based, at least in part, on the plurality of historical transactions, wherein the second plurality of embeddings are representative of similarities amongst the payees, and
wherein to generate the training data for the machine learning model, the computer executable instructions, when executed by the one or more processors, cause the one or more processors to combine the first plurality of embeddings and the second plurality of embeddings to form the training data.

13. The system of claim 12, wherein to generate the second plurality of embeddings, the computer executable instructions, when executed by the one or more processors, cause the one or more processors to generate a plurality of sentences based on the historical transactions, wherein each of the sentences corresponds to a respective historical transaction and includes: (i) a respective payor and payee combination; and (ii) a description of the payee.

14. The system of claim 13, wherein to generate the plurality of sentences, the computer executable instructions, when executed by the one or more processors, cause the one or more processors to generate the plurality of sentences by, for each of the plurality of historical transactions, concatenating the description of the respective payee to the respective payor and payee combination.

15. The system of claim 9, wherein to train the machine learning model, the computer executable instructions, when executed by the one or more processors, cause the one or more processors to:
provide training inputs from the training data to the machine learning model;
obtain outputs from the machine learning model based on the training inputs; and
iteratively adjust parameters of the machine learning model based on comparing the outputs to labels associated with the training inputs in the training data.

16. A method comprising:
receiving a plurality of uncategorized transactions involving a payor and a plurality of different payees;
retrieving a machine learning model that has been trained through a supervised learning process based on labeled training data that includes a plurality of embeddings, wherein each of the embeddings is representative of an industry name associated with one or more payors involved in historical transactions of a first type;
providing inputs to the machine learning model based, at least in part, on the plurality of uncategorized transactions;
receiving, from the machine learning model, a plurality of predictions, each of the predictions indicative of a respective transaction of the plurality of uncategorized transactions being of the first type or a second type; and
displaying, via a user interface, the plurality of predictions.

17. The method of claim 16, further comprising:
receiving, via the user interface, user feedback on one or more predictions of the plurality of predictions.

18. The method of claim 17, further comprising:
generating updated training data for the machine learning model based, at least in part, on the user feedback, wherein the updated training data is used to re-train the machine learning model.

19. The method of claim 16, wherein the first type includes a business transaction and the second type includes a personal transaction.

20. The method of claim 16, wherein the machine learning model comprises a neural network.
